(19) United States
(12) Patent Application Publication
(10) Pub. No.: US 2006/0241534 A1
(43) Pub. Date: Oct. 26, 2006

(54) Electric thermal waist belt

(76) Inventor: Sam Tsai, JhongHe City (TW)

Correspondence Address: RABIN & Berdo, PC, 1101 14TH STREET, NW, SUITE 500, WASHINGTON, DC, 20005, US

(21) Appl. No.: 11/109,635

(22) Filed: Apr. 20, 2005

(51) Int. Cl. A61H 11/00

(52) U.S. Cl. 601/15

(57) ABSTRACT

The present invention relates to an electric thermal waist belt, which comprises a plurality of layers of belt sheaths made of a polyvinyl chloride (PVC), at least two lining pads made of a flameproof polyurethane (PU) foam, a fastener, a power switch, and an electrothermal layer comprising a circuit of heating wire and at least two multi-apertured surfaces, wherein the circuit of heating wire is placed in between the two multi-apertured surfaces forming a double layers structure and connect to the power switch, a inner part of on of the lining pad comprises a foil, the other lining pad comprises a plurality of side pads. The lining pads cover the electrothermal layer and are placed in between the belt sheaths, sewing the belt sheaths produces an electric thermal waist belt performing a proper temperature between 35˜60° C. for health.

### BACKGROUND OF THE INVENTION

1. Field of the Invention

The present invention relates to an electric thermal waist belt, which particularly relates to waist belt performing a stable heat at temperature intervals between 35˜60° C. on the surface of the waist belt for health.

2. Description of the Related Art

The normal waist belts in the prior arts commonly comprise a set of heating wire covered in the belt, and the waist belt can perform as a hot compress for health when heating wire is connected to a power supply. The structure of prior arts is too poor to stable the temperature of the waist belt, and some area on the surface may overheat and some area may be cold. Overheating may cause heat damage to skin even worse to a burn.

Some improvements in the prior arts utilize polyurethane (PU) foam to cover the heating wire to prevent overheating. The direct contact of the heating wire partially deteriorates the PU foam along the heating wire, and soon the whole waist belt will be unusable.

### SUMMARY OF THE INVENTION

The present invention relates to a healthy waist belt with electric heat, which is easy operation, safe, and temperature stable between 35˜60° C. on the surface as a proper hot compress for health. The electric thermal waist belt of the present invention comprises a plurality of belt sheaths made of polyvinyl chloride (PVC) in a thickness of 0.3±0.05 mm, at least two lining pads made of flameproof polyurethane (PU) foam in a thickness of 3˜8 mm and a density of 18 kg/m³ and covered by the belt sheaths, a fastener, a power switch, and an electrothermal layer.

The fastener is set at two ends of the belt sheath for fix around waist. The outside lining pad comprising a foil adhered, which faces the electrothermal layer, and the power switch is connected to the heating wire to operate.

The electrothermal layer is placed in between two lining pads and comprises a circuit of heating wire and at least two multi-apertured surfaces that the circuit of heating wire is placed in between. The circuit of heating wire further comprises a thermostat and connects to the power switch to be operated, and the thermostat set heating under 85° C. to stabilize the temperature to prevent overheating burn. The circruit of the heating wire is laid along holes of the multi-apertured surfaces of the electrothermal layer. The holes help radiation of the heating wire so that it can save energy, and the foil of the lining pad reflects and equalizes the heat to prevent a hot spot on the surface of the belt sheath.

The power switch comprises a power regulator, a power cord, and a power indicator light, and connects to the power supply and to the circuit of heating wire to regulate power output to set the waist belt at a proper temperature.

The waist belt further comprises two side pads that is made of PU foam in a thickness of 2˜6 mm. The side pads are set at the ends of the inner lining pad and provide a special buffer of heat for waist.

The belt sheaths are sewed to cover the lining pads comprising the electrothermal layer to complete the electric thermal waist belt. With plugging the power cord into the outlet and the power regulator controlling in 10˜50 watt power output, the electric thermal waist belt provides a hot compress in a stable and proper heat which is about 35˜60° C. on the surface of the belt sheath around the waist.

### BRIEF DESCRIPTION OF THE DRAWINGS

FIG. 1 is a diagram of the perspective view of the present invention;

FIG. 2 is a diagram of the exploded view of the present invention;

FIG. 3 is a diagram of the sectional view of the present invention.

### DETAILED DESCRIPTION OF THE PREFERRED EMBODIMENTS

In the following description of the embodiments of the present invention, please refer to the drawings.

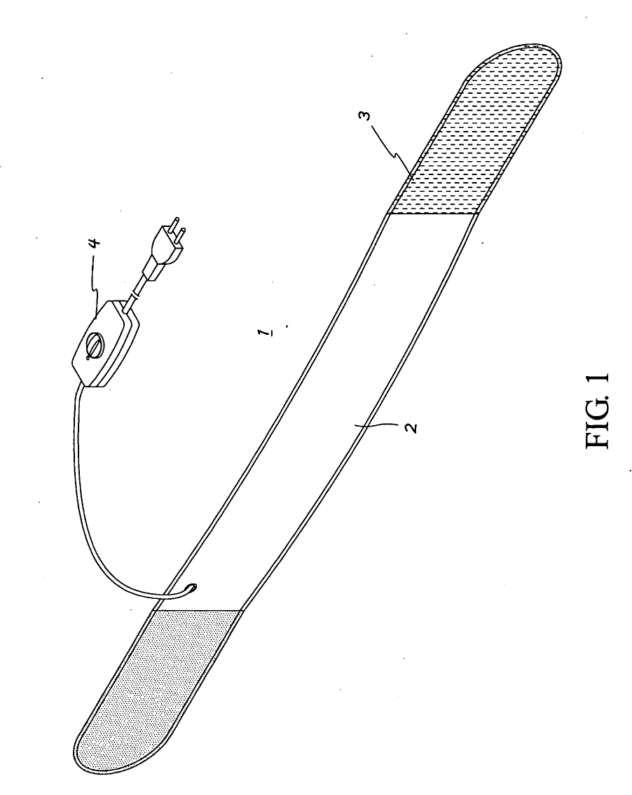

As shown in FIG. 1, the perspective view of an embodiment of the present invention, an electric thermal waist belt 1 is disclosed. The electric thermal waist belt 1 of the present invention is tied around the waist with electric heat for health, which comprises a belt sheath 2, a set of fastener 3, and a power switch 4. The belt sheath 2 is made of two layers of a PVC in thickness of 0.3±0.05 mm. The set of fastener 3 comprises a Velcro hook and loop fastener. The power switch 4 extends from the belt 1 for operation.

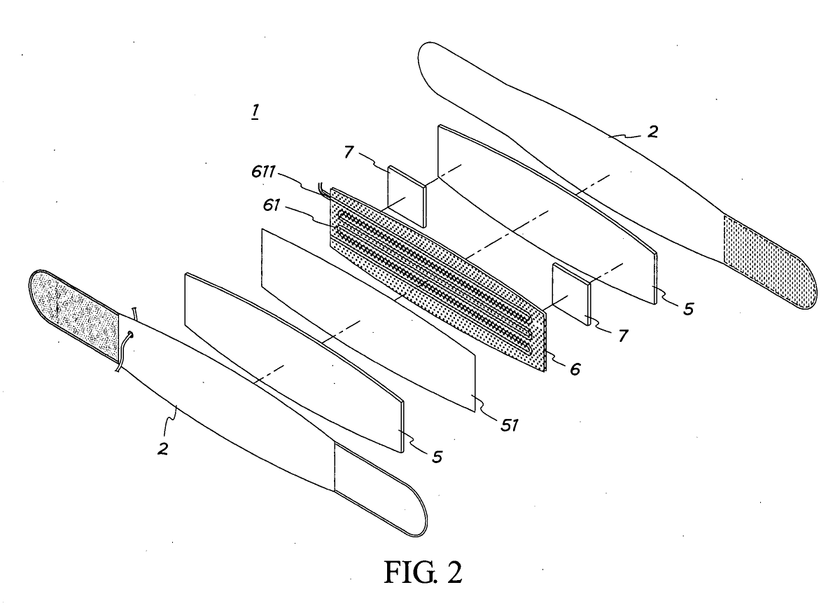

The exploded view of the present invention is as shown in the FIG. 2. The electric thermal waist belt 1 of the present invention further comprises a lining pad 5, two side pads 7, and an electrothermal layer 6. The electrothermal layer 6 is placed between two lining pads 5, wherein the lining pad 5 further comprises a aluminum foil 51 attached, which faces the electrothermal layer 6, and the side pads 7 are placed in between the lining pad 5 and the electrothermal layer 6. The lining pad 5 is made of a flameproof PU foam in a thickness of 5 mm and a density of 18 kg/m³, and the side pad 7 is also made of a flameproof PU foam in a thickness of 3 mm. The foil 51 is made of aluminum to reflect and to transmit heat from the electrothermal layer 6 to equalize the temperature. The power switch (not shown in this figure) connects to the electrothermal layer 6 to operate. The belt sheath 2 covers the lining pads 5 and is sewed.

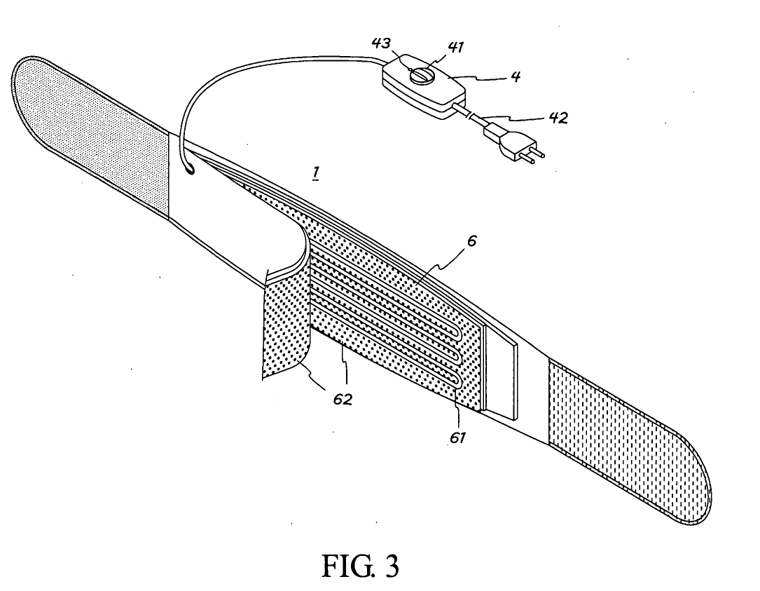

Please refer to the FIG. 3, which is the diagram of the sectional view of the embodiment of the present invention. The electrothermal layer 6 is a double layers structure, which comprises a circuit of heating wire 61 inside and a multi-apertured surface 62 that the heating wire 61 is placed in. The circuit of heating wire 61 comprises a thermostat 611 (as shown in the FIG. 2) to stabilize the temperature of the waist belt 1 constant. The power switch 4 further comprises a power regulator 41, a power cord 42, and a power indicator light 43. The power regulator 41 controls the power output of the electrothermal layer 6 to set a proper temperature. The power cord 42 connects to a power supply or an outlet on the wall. The power indicator light 43 indicates the status of operation of the waist belt 1.

The foregoing describing of the preferred embodiment of the invention is for the purpose of illustration and description. It is not intended to exhaustive or to limit the invention to the precise from disclosed. Many other possible modifications and variations can be made without departing from the scope of the present invention, which following claims are depended.

What is claimed is:

1. An electric thermal waist belt, which comprises a plurality of belt sheaths, at least two lining pads made of flameproof polyurethane foam, a set of fastener, a power switch, and an electrothermal layer, wherein
the fastener is set at two ends of the belt sheath for fix around waist;
the electrothermal layer comprises a circuit of heating wire and at least two multi-apertured surfaces for the circuit of heating wire to be placed in between, and the circuit of heating wire connects to the power switch;
the power switch connects to a power supply and to the circuit of heating wire; and the electrothermal layer is placed in between the lining pads, and sewing the belt sheaths to cover the lining pads completes the electric thermal waist belt.

2. An electronic thermal waist belt according to the claim 1, wherein the belt sheath is made of polyvinyl chloride (PVC) in a thickness of 0.3±0.05 mm.

3. An electronic thermal waist belt according to the claim 1, wherein the lining pad is made of flameproof polyurethane (PU) foam in a thickness of 3˜8 mm and a density of 18 kg/m³.

4. An electronic thermal waist belt according to the claim 1, wherein the lining pad comprises a foil.

5. An electronic thermal waist belt according to the claim 1, wherein the lining pad comprises a plurality of side pads.

6. An electronic thermal waist belt according to the claim 5, wherein the side pad is made of flameproof polyurethane (PU) foam in a thickness of 2˜6 mm.

7. An electronic thermal waist belt according to the claim 1, wherein the power switch comprises a power regulator, a power cord, and a power indicator light.

8. An electronic thermal waist belt according to the claim 7, wherein the power regulator regulates power output from 10 to 50 watt.

9. An electronic thermal waist belt according to the claim 1, wherein the circuit of heating wire comprises a thermostat, which sets the maximum temperature.

10. An electronic thermal waist belt according to the claim 9, wherein the thermostat is pre-set the maximum temperature at 85° C.
